(19) United States
(12) Patent Application Publication
(10) Pub. No.: US 2025/0123456 A1
(43) Pub. Date: Apr. 17, 2025

(54) OPTICAL MODULE

(71) Applicant: Innolight Technology(ChengDu)LTD., Chengdu, Sichuan (CN)

(72) Inventors: Yin Wei, Chengdu, Sichuan (CN); Lan Yang, Chengdu, Sichuan (CN); Xiu-Ling Deng, Chengdu, Sichuan (CN); Peng Xiao, Chengdu, Sichuan (CN); Ju-Lin Zhang, Chengdu, Sichuan (CN); Qing Huang, Chengdu, Sichuan (CN); Gang Chen, Chengdu, Sichuan (CN)

(21) Appl. No.: 18/721,230

(22) PCT Filed: Nov. 10, 2022
(86) PCT No.: PCT/CN2022/131066

§ 371 Date: Dec. 17, 2024

(30) Foreign Application Priority Data
Dec. 24, 2021 (CN) 202111594609.2

(51) Int. Cl. G02B 6/42

(52) U.S. Cl. CPC G02B 6/428; G02B 6/4269

(57) ABSTRACT

An optical module, comprising a circuit board (110), a photoelectric assembly (130) electrically connected to the circuit board (110), an optical interface (120), and optical fiber (140) in optical communication with the photoelectric assembly (130) and the optical interface (120), and a fiber coiling member (150). The fiber coiling member (150) comprises a fiber coiling body (151) enclosing an accommodating cavity (1510), and the fiber coiling body (151) is provided with a bottom wall (1512) and a fiber coiling wall (1511) extending from the bottom wall (1512) in the thickness direction of the circuit board (110). The fiber coiling wall (1511) defines a peripheral boundary of the accommodating cavity (1510). The fiber coiling member (150) further comprises stop walls (152) arranged opposite to the bottom wall (1512) in the thickness direction of the circuit board (110), and protruding from the fiber coiling wall (1511) to the interior of the accommodating cavity (1510). The accommodating cavity (1510) is provided with a stop space formed between the stop walls (152) and the bottom wall (1512), and the optical fiber (140) coils and extends along the fiber coiling wall (1511) and is limited in the stop space by the strop walls (152). The fiber coiling efficiency of the fiber coiling member (150) is high, and the bending radius of the optical fiber remains unchanged at will.

### FIELD OF THE DISCLOSURE

The present disclosure relates to the technological field of manufacturing of optical communication elements, particularly relates to an optical module, and more particularly to an optical module with a fiber coiling mechanism.

### BACKGROUND OF THE DISCLOSURE

One of the core links of optical fiber communication is the conversion between optical and electrical signals. Optical fiber communication uses optical signals carrying information to transmit in information transmission apparatuses such as optical fiber/optical waveguide; the passive transmission characteristics of light in optical fiber/optical waveguide can achieve low-cost and low-loss information transmission, while information processing equipment such as computers use electrical signals. In order to establish an information connection between information transmission apparatuses such as optical fiber/optical waveguide and information processing apparatuses such as computers, it is necessary to achieve the conversion between electrical and optical signals.

Optical modules realize the above-mentioned mutual conversion function of optical and electrical signals in the field of optical fiber communication technology. The mutual conversion of optical signals and electrical signals is the core function of optical modules. Optical modules realize electrical connection with external host computers through the gold fingers on their internal circuit boards. The main electrical connections include power supply, I2C signals, data signals, and grounding. Optical modules realize optical connection with external optical fibers through optical interfaces. There are many ways to connect external optical fibers, which derive various types of optical fiber connectors, such as LC interfaces, SC interfaces, and MPO interfaces.

Inside the optical module, the photoelectric assembly is a core functional component used to convert the electrical signal of the circuit board into an optical signal for output by the optical interface, and/or to convert the optical signal received by the optical interface from the external optical fiber into an electrical signal; optical fibers are often used to achieve optical communication between the photoelectric assembly and the optical interface.

Among the optical module products having internal optical fibers, one configuration manner of the optical fiber is direct connection; that is, the length of the optical fiber basically equals to the distance between the photoelectric assembly and the optical interface, such that the optical fiber extends in a straight line between the photoelectric assembly and the optical interface. This manner allows for a relatively simple assembly, but there exists problems such as difficulty in controlling the optical fiber length and optical fiber breakage due to stress during reliability testing.

Another configuration manner for the optical fiber is the fiber coiling method, in which the length of the optical fiber is much longer than the distance between the photoelectric assembly and the optical interface, and the optical fiber is arranged inside the optical module by coiling. This manner can avoid the problem of optical fiber breakage due to stress in the direct connection manner, but has problems such as complex operation, long processing hours, and difficulty in ensuring the bending radius of the optical fiber, which affects the power of the optical module.

### SUMMARY OF THE DISCLOSURE

In order to solve the problems in the prior art of complex fiber coiling operation, long processing time, and difficulty in ensuring the bending radius of the optical fiber, which affects the power of the optical module, the present disclosure provides an optical module.

In order to solve the above-mentioned problems, one of the technical aspects adopted by the present disclosure is to provide an optical module. The optical module includes a circuit board, a photoelectric assembly electrically connected to the circuit board, an optical interface, an optical fiber in optical communication with the photoelectric assembly and the optical interface, and a fiber coiling member. The fiber coiling member includes:
a fiber coiling body enclosing an accommodating cavity, and the fiber coiling body is provided with a bottom wall and a fiber coiling wall extending from the bottom wall in the thickness direction of the circuit board, wherein the fiber coiling wall defines a peripheral boundary of the accommodating cavity; and
a stop wall arranged opposite to the bottom wall in the thickness direction of the circuit board and protruding from the fiber coiling wall to the interior of the accommodating cavity, and the accommodating cavity is provided with a stop space formed between the stop wall and the bottom wall;
in which, the optical fiber coils and extends along the fiber coiling wall and is limited in the stop space by the stop wall.

As a further improvement on the embodiments, the fiber coiling member includes plurality ones of the stop wall spaced apart from each other and arranged around the accommodating cavity, the fiber coiling member limits an optical fiber installation channel formed at each of the stop walls for the optical fiber to enter or leave the stop space, and all of the fiber installation channels are arranged to be open away from the bottom wall or are arranged to be open away from the fiber coiling wall.

As a further improvement on the embodiments, the fiber coiling member further includes a guide wall located in the accommodating cavity and is in-out opposite to the fiber coiling wall, and the guide wall extends from one of the bottom wall and the stop wall along the thickness direction of the circuit board, and is spaced apart from another one of the bottom wall and the stop wall to form an optical fiber installation channel.

As a further improvement on the embodiments, the optical module further includes a heat sink; in which the heat sink has a first surface and a second surface arranged opposite to each other along the thickness direction of the circuit board, at least part of the photoelectric assembly and the circuit board are installed on the first surface, and the fiber coil is located on a side that the second surface is located;
the heat sink further has a through hole connecting the first surface and the second surface, and the optical fiber passes through the through hole between a side that the first surface is located and the side that the second surface is located.

As a further improvement on the embodiments, the optical module further includes a flexible protective sleeve sleeved on the outer periphery of the optical fiber, in which the flexible protective sleeve is located at least at a junction between the optical fiber and the through hole.

As a further improvement on the embodiments, the photoelectric assembly includes a first optical device installed on the first surface;
a number of the through hole is set to one; a portion of the optical fiber is coiled in the fiber coiling member, one end of the optical fiber passes through the through hole to the side that the first surface is located to optically couple with the first optical device, and another end of the optical fiber is connected to the optical interface;
alternatively, a number of the through hole is set to two; a portion of the optical fiber is coiled in the fiber coiling member, one end of the optical fiber passes through one of the through holes to the side that the first surface is located to optically couple with the first optical device, and another end of the optical fiber passes through another one of the through holes to the side that the first surface is located to be connected to the optical interface.

As a further improvement on the embodiments, the photoelectric assembly includes:
an optical emission assembly connected to the optical interface through the optical fiber; and/or
an optical receiving assembly connected to the optical interface through the optical fiber.

As a further improvement on the embodiments, the first optical device is configured as a coupling lens, and one end of the optical fiber is coupled to the coupling lens via a glass head;
alternatively, the first optical device is configured as an array waveguide grating, and one end of the optical fiber is coupled and adhered to an emission end surface of the array waveguide grating via a glass head.

As a further improvement on the embodiments, the optical emission assembly includes any of a collimating lens, a Mux multiplexer, a first periscope, and a second periscope located in an incident optical path of the coupling lens;
alternatively, the optical emission assembly includes a collimating lens and an isolator located in an optical path between the array waveguide grating;
alternatively, the optical emission assembly includes a second optical fiber located in an optical path between the array waveguide grating, one end of the second optical fiber is coupled and adhered to a receiving end surface of the array waveguide grating through a second glass head, and the second glass head and the glass head are located on a same side of the array waveguide grating and are integrally arranged.

As a further improvement on the embodiments, the optical interface is located in front of the circuit board;
a rear end portion of the fiber coiling body overlaps with the circuit board along the thickness direction of the circuit board; and a front end portion of the fiber coiling body extends forward from the circuit board.

As a further improvement on the embodiments, the front end portion of the fiber coiling body has a through groove formed on the bottom wall for the optical fiber to pass through the accommodating cavity;
the fiber coiling wall is arranged around the accommodating cavity in a closed ring shape.

As a further improvement on the embodiments, the fiber coiling member is fixedly installed on the second surface of the heat sink by any structure of a screw member, a glue, or a buckle.

Compared with the commonly used technology, the technical effect of the present disclosure is that, on the one hand, the optical fiber can be stably attached to the inner side of the fiber coiling wall by utilizing its own tension when it is bent; no matter whether the optical fiber is coiled in a single circle or multiple circles in the fiber coiling member, the bending radius of the optical fiber can be ensued to always meet the requirements and does not change inadvertently, thereby ensuring the power stability of the optical module. On the other hand, there is no need to deliberately correct the position/bending radius of the optical fiber during the fiber coiling process, and the optical fiber can be coiled quickly and easily, thereby improving the fiber coiling efficiency and saving the fiber coiling time.

### BRIEF DESCRIPTION OF THE DRAWINGS

FIG. 1 is a perspective structural view of an optical module from one viewing angle according to a first embodiment of the present disclosure;

FIG. 2 is an exploded structural view of the optical module according to the first embodiment of the present disclosure;

FIG. 3 is a perspective structural view of the optical module from another viewing angle according to the first embodiment of the present disclosure;

FIG. 4 is a perspective structural view of a fiber coiling member according to the first embodiment of the present disclosure;

FIG. 5 is a cross-sectional view taken along line 1A-1A in FIG. 4;

FIG. 6 is a perspective structural view of a heat sink according to the first embodiment of the present disclosure;

FIG. 7 is a perspective structural view of a fiber coiling member of an optical module according to a second embodiment of the present disclosure;

FIG. 8 is a cross-sectional view along line 2A-2A in FIG. 7;

FIG. 9 is a schematic view of a simplified structural framework of an optical module according to a third embodiment of the present disclosure; and

FIG. 10 is a schematic view of a simplified structural framework of an optical module according to a fourth embodiment of the present disclosure.

### DETAILED DESCRIPTION OF THE EXEMPLARY EMBODIMENTS

The present application will be described in detail below in conjunction with the specific implementations as shown in the accompanying drawings. However, these implementations do not limit the present application, and any structural, methodological, or functional changes made by a person of ordinary skill in the art based on these implementations are all included in the protection scope of the present application.

The terms used in this application are only for the purpose of describing specific embodiments and are not intended to limit the present application. The singular forms of “a”, “an” and “the” used in the present application and the appended claims are also intended to include plural forms unless the context clearly indicates otherwise. It should also be understood that the term “and/or” used in this specification refers to and includes any or all possible combinations of one or more associated items that are listed.

First, in order to overcome the technical problems as mentioned in the background technology, the present application provides an optical module. It should be noted that the optical module mentioned in the present application can be suitable for sending and/or receiving optical signals at various data rates per second, and the data rates per second include but are not limited to: 1 gigabit per second (Gbit), 2 Gbit, 4 Gbit, 8 Gbit, 10 Gbit, 20 Gbit, 100 Gbit, 400 Gbit, 800 Gbit, or other bandwidth of optical fiber links. In addition, optical modules of other types and configurations or optical modules with components different from those shown and described herein in certain aspects may also benefit from the principles disclosed herein.

Certain manners of implementation of the present application are described in detail below in conjunction with the accompanying drawings. In the absence of conflict, the following embodiments and features in the embodiments may be combined with each other.

### First Embodiment

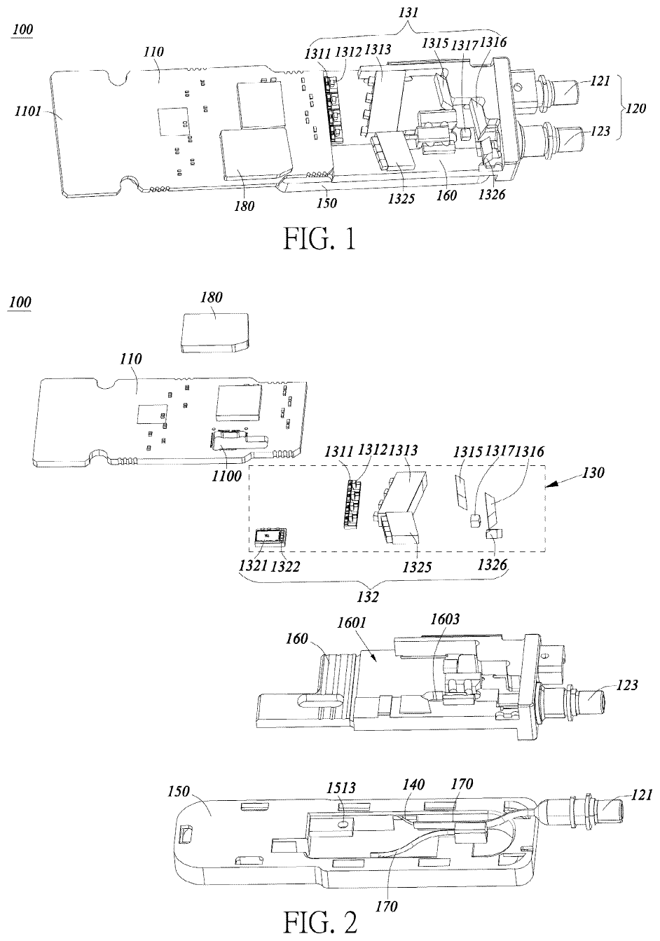

Referring to FIG. 1 and FIG. 2, this embodiment provides an optical module 100, which includes a circuit board 110, an optical interface 120, a photoelectric assembly 130, and an optical fiber 140.

In which, one end of the optical module 100 realizes electrical connection with an external host computer through a gold finger 1101 of the circuit board 110, and the main electrical connections include power supply, I2C signal, data signal and grounding, etc.; and another end of the optical module 100 realizes optical connection with an external optical fiber through the optical interface 120. In this application, for ease of understanding and description, the front-rear direction is defined by the relative direction of the optical interface 120 and the gold finger 1101, in which the gold finger 1101 is relatively at the rear and the optical interface 120 is relatively at the front.

The circuit board 110 is a thin plate structure with a thickness defined in a top-down direction. In other words, the circuit board 110 has two main surfaces that are top-down opposite to each other, and the distance between the two main surfaces substantially defines the thickness of the circuit board 110. In this application, for ease of understanding and description, the top-down direction is defined by the thickness direction of the circuit board 110.

In the present application, the top-down direction and the front-rear direction are substantially perpendicular to each other.

The circuit board 110 can be specifically configured as a copper-clad laminate, having an inner layer and/or surface layer formed with circuit traces, and the two main surfaces of the circuit board 110 can also be installed with electronic components (such as capacitors, resistors, triodes, MOS tubes) and chips (such as MCU, clock data recovery (CDR), power management chip, and data processing chip (DSP)), etc. These electronic components and chips, as well as other electrical devices in the optical module 100 (such as the optical emission chip, optical receiving chip, transimpedance amplifier, etc., that are described in the following descriptions), can be connected together according to the circuit design via the circuit traces of the circuit board 110.

In addition, the circuit board 110 can be specifically configured as a hard circuit board, a flexible circuit board, or a flexible-hard combination board, which can be implemented in any feasible manner known in the art and will not be described in detail.

Next, the photoelectric assembly 130 is electrically connected to the circuit board 110 and optically connected to the optical interface 120, which serves as a core component for implementing conversion between optical signals and electrical signals of the optical module 100.

Specifically, in the present embodiment shown in the accompanying drawings, the optical module 100 is configured as an integrated optical transceiver having both optical emission and optical receiving functions. Reference is made in conjunction with FIG. 1 and FIG. 2, and the photoelectric assembly 130 includes an optical emission assembly 131 and an optical receiving assembly 132. The optical emission assembly 131 is electrically connected to the circuit board 110 and optically connected to the optical interface 120, and is used to convert the electrical signal from the circuit board 110 into an optical signal, and transmit the optical signal through the optical interface 120 to the outside of the optical module 100 (for example, to the above-mentioned external optical fiber); and the optical receiving assembly 132 is electrically connected to the circuit board 110 and optically connected to the optical interface 120, and is used to convert the optical signal received by the optical interface 120 from the external optical fiber into an electrical signal, and output the electrical signal to the circuit board 110.

Naturally, it can be understood that the optical module of the present application is not limited to the optical transceiver of the embodiment shown in the accompanying drawings. For example, in a variant embodiment, the optical module can be an optical transmitter (TOSA) having only an optical emission function, and accordingly, its photoelectric assembly is configured to be an optical emission assembly (for example, in the embodiment as shown in FIG. 1, the optical receiving assembly 132 is removed and only the optical emission assembly 131 is retained); in another variant embodiment, the optical module can be an optical receiver (ROSA) having only an optical receiving function, and accordingly, its photoelectric assembly is configured to be an optical receiving assembly (for example, in the embodiment as shown in FIG. 1, the optical emission assembly 131 is removed and only the optical receiving assembly 132 is retained).

In the present embodiment as shown in the drawings, the optical interface 120 includes an optical emission interface 121 and an optical receiving interface 123. The optical emission interface 121 optically connects to the optical emission assembly 131, so as to output the optical signal emitted by the optical emission assembly 131 to the external optical fiber of the optical module 100; the optical receiving interface 123 is optically connected to the optical receiving assembly 132, so as to input the optical signal received from the external optical fiber of the optical module 100 to the optical receiving assembly 132. Accordingly, when the optical module is implemented as an optical transmitter or an optical receiver according to the abovementioned description, the optical interface 120 is correspondingly implemented to retain only the optical emission interface 121 or the optical receiving interface 123.

A first end of the optical fiber 140 is optically connected to the photoelectric assembly 130, and a second end thereof is optically connected to the optical interface 120, so as to optically connect the photoelectric assembly 130 and the optical interface 120, such that the optical signal can be transmitted between the photoelectric assembly 130 and the optical interface 120 via the optical fiber 140.

In the embodiment of the accompanying figures, the optical fiber 140 is specifically implemented in an optical emission optical path of the optical module 100, that is, it optically connects the optical emission assembly 131 and the optical emission interface 121, and the length of the optical fiber 140 is much greater than the distance between the optical emission interface 121 and the last optical device 1317 (specifically, it can be a coupling lens as described in the following) of the optical emission assembly 131. The original intention of the invention of this application is to at least solve the problem of winding of the optical fiber 140. It can be understood that under the original intention of the invention of this application, the optical fiber 140 can also be implemented in the light receiving optical path of the optical module 100; that is, it optically connects the light receiving assembly 132 and the optical receiving interface 123. Accordingly, the length of the optical fiber 140 is much greater than the distance between the optical receiving interface 123 and a first optical device of the light receiving assembly 132. This variation of implementation can also benefit from the principles disclosed herein.

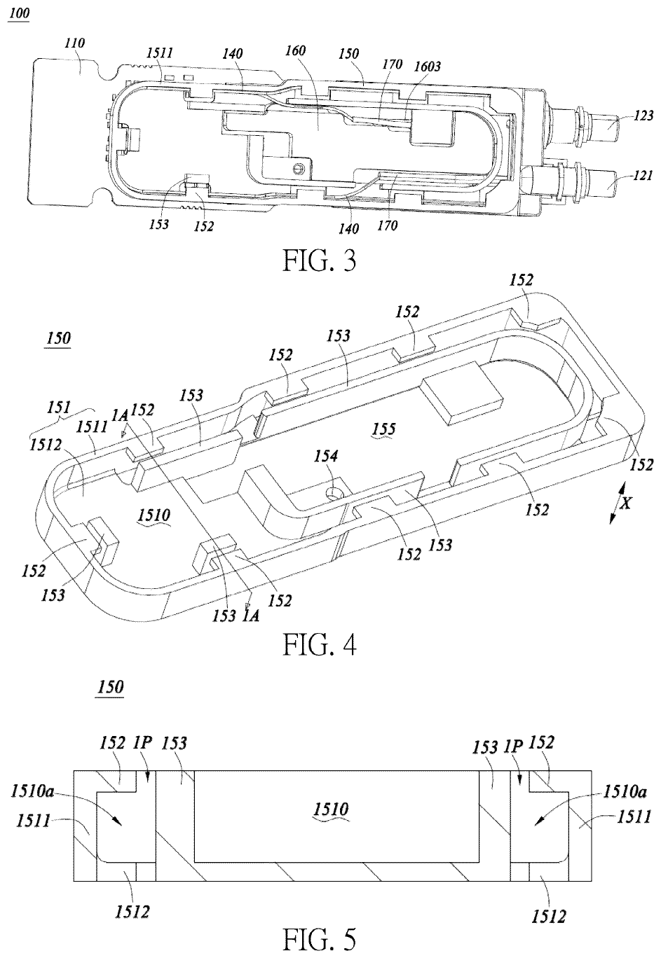

In detail, referring to FIG. 3 to FIG. 5, the optical module 100 of the present application includes a fiber coiling member 150. The fiber coiling member 150 includes a fiber coiling body 151 and a stop wall 152.

In which, the fiber coiling body 151 encloses an accommodating cavity 1510, which has a fiber coiling wall 1511 that defines four sides of the accommodating cavity 1510 and a bottom wall 1512 connected to the fiber coiling wall 1511; the fiber coiling wall 1511 extends from the bottom wall 1512 along the thickness direction of the circuit board 110, and one side of the accommodating cavity 1510 in the thickness direction of the circuit board 110 is open and a boundary of another side is defined by the bottom wall 1512.

The stop wall 152 is disposed opposite to the bottom wall 1512 in the thickness direction of the circuit board 110, and protrudes from the edge of the fiber coiling wall 1511 (the edge is away from the bottom wall 1512) toward the inside of the accommodating cavity 1510. Based on the positional relationship between the stop wall 152 and the bottom wall 1512, the accommodating cavity 1510 has a stop space 1510a formed between the stop wall 152 and the bottom wall 1512.

The optical fiber 140 is arranged in the accommodating cavity 1510 and is coiled and extended along the fiber coiling wall 1511; at the same time, when the optical fiber 140 is coiled along the fiber coiling wall 1511, in the thickness direction of the circuit board 110, the optical fiber 140 is limited in the stop space 1510a by the stop wall 152 and will not separate from the fiber coiling wall 1511 in a direction away from the bottom wall 1512.

Thus, in the present application, the optical fiber 140 is coiled in the accommodating cavity 1510, and the fiber coiling wall 1511 is used for peripheral limiting, and the bottom wall 1512 and the stop wall 152 are used for bidirectional limiting in the thickness direction of the circuit board 110. On the one hand, the tension of the optical fiber 140 that is bent can be utilized to stably attach on an inner side of the fiber coiling wall 1511. Regardless of whether the optical fiber 140 is coiled in a single turn or multiple turns in the fiber coiling member 150, the bending radius of the optical fiber 140 is ensured to always meet the requirements and will not be changed inadvertently, thereby ensuring the power stability of the optical module 100. On the other hand, there is no need to deliberately correct the position/bending radius of the optical fiber 140 during the fiber coiling process, and the optical fiber 140 can be quickly and easily coiled, thereby improving the fiber coiling efficiency and saving the fiber coiling time.

Furthermore, the fiber coiling member 150 includes plurality ones of the stop wall 152, and the stop walls 152 are spaced apart from each other and arranged around the accommodating cavity 1510. At the same time, the fiber coiling member 150 limits an optical fiber installation channel 1P formed at each of the stop walls 152. When the optical fiber 140 is coiled into the fiber coiling member 150, the optical fiber 140 can enter the stop space 1510a on one side of the stop walls 152 through each of the optical fiber installation channels 1P; naturally, conversely, when the optical fiber 140 coiled on the fiber coiling member 150 needs to be removed, the optical fiber 140 can also be separated from the stop space 1510a through each of the optical fiber installation channels 1P.

In this embodiment, all the optical fiber installation channels 1P are configured to be open away from the bottom wall 1512, that is, they are open toward the outside of the accommodating cavity 1510 along the thickness direction of the circuit board 110. In this way, when the optical fiber 140 is coiled into the fiber coiling member 150, the optical fiber 140 is clamped and installed along the thickness direction of the circuit board 110 toward the bottom wall 1512 at each of the optical fiber installation channels 1P, and there is no need to change a clamping direction of the optical fiber 140 at multiple angles, such that the installation of the optical fiber 140 is fast and simple, thereby improving the fiber coiling efficiency, and saving the fiber coiling time.

Specifically, the fiber coiling member 150 includes a guide wall 153 located in the accommodating cavity 1510. The guide wall 153 is in-out opposite to the fiber coiling wall 1511 and extends from the bottom wall 1512 along the thickness direction of the circuit board 110, and is spaced apart from an inner edge of the stop wall 152 (i.e., an edge away from the fiber coiling wall 1511) to form the optical fiber installation channel 1P.

As shown in the figure, the guide wall 153 respectively corresponding to two adjacent stop walls 152 can be configured as two plate structures spaced apart from each other, or can be connected to form a complete plate structure without obvious boundaries. These implementations do not deviate from the technical purposes of the present application.

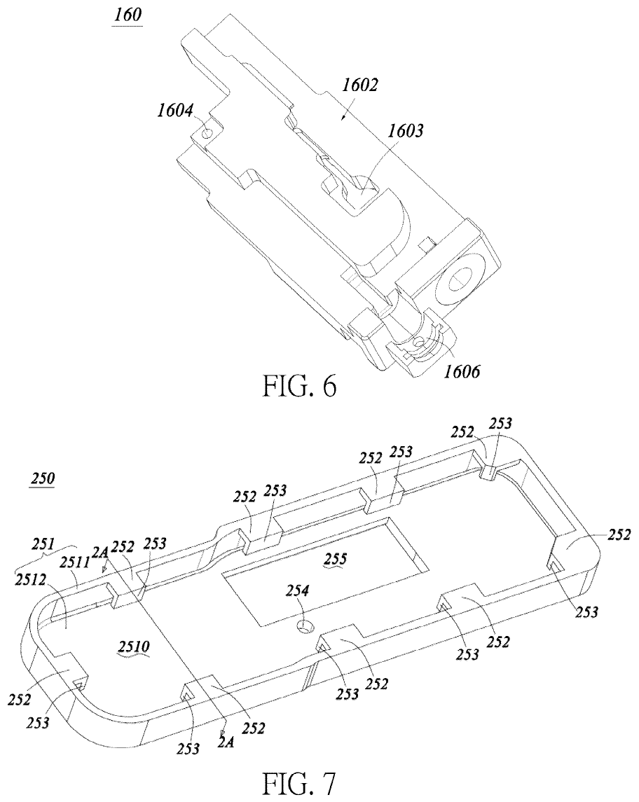

Further, reference is made in conjunction with FIG. 2 and FIG. 6, the optical module 100 further includes a heat sink 160, and the heat sink 160 has a first surface 1601 and a second surface 1602 that are arranged opposite to each other in the top-down direction. In the top-down direction, at least a part of the optical emission assembly 131 and the circuit board 110 are located on a side that the first surface 1601 of the heat sink 160 is located, and the side is equivalent to a front side of the optical module 100; the fiber coiling member 150 is located on a side that the second surface 1602 of the heat sink 160 is located, and the side is equivalent to a rear side of the optical module 100. In this way, at least a part of the optical emission assembly 131 and the circuit board 110 and the fiber coiling member 150 are separated on opposite sides of the heat sink 160 in the top-down direction, such that the space on the rear side of the heat sink 160 can be fully utilized for routing the optical fiber 140; the space for placing optical paths and electrical components on the front side of the heat sink 160 can be avoided from being occupied, which is beneficial to the overall structural layout inside the optical module 100, and further facilitates the compactness and miniaturization of the optical module 100.

The heat sink 160 has a through hole 1603 connecting the first surface 1601 and the second surface 1602. The optical fiber 140 passes through the through hole 1603 between the side that the first surface 1601 is located and the side that the second surface 1602 is located. In this way, at least one end of the optical fiber 140 (that is, at least one of the first end and the second end of the optical fiber 140) can be arranged on the side that the first surface 1601 is located, and at the same time, a middle section of the optical fiber 140 can be coiled on the side that the second surface 1602 is located.

In this embodiment, a number of the through holes 1603 is set to one, the first end of the optical fiber 140 is arranged on the side that the first surface 1601 is located, and the second end is arranged on the side that the second surface 1602 is located. Specifically, referring to FIG. 1, the optical device 1317 (specifically, a coupling lens) included in the optical emission assembly 131 is installed on the first surface 1601 of the heat sink 160; furthermore, a fixing groove 1606 is formed on the second surface 1602 of the heat sink 160, and the optical emission interface 121 is fixed in the fixing groove 1606 by means of structural adhesive or laser welding. The middle section of the optical fiber 140 is coiled in the fiber coiling member 150 on the side that the second surface 1602 is located. The first end of the optical fiber 140 passes through the through hole 1603 to the side that the first surface 1601 of the heat sink 160 is located and is optically coupled to the optical device 1317; moreover, the second end of the optical fiber 140 is fixedly connected to the optical emission interface 121 by structural adhesive. In this way, the second end of the optical fiber 140 does not need to pass from the side that the second surface 1602 is located back to the side that the first surface 1601 is located, such that the structure is simple and the layout is reasonable.

Herein, it can be understood that, in a variant embodiment, the installation manner of the optical device 1317 and the first end of the optical fiber 140 can be the same as that of the illustrated embodiment, and the optical emission interface 121 is changed to be installed on the first surface 1601 of the heat sink 160. Accordingly, the heat sink 160 is provided with an additional through hole 1603, and the second end of the optical fiber 140 is changed to pass through the additional through hole 1603 to the side that the first surface 1601 of the heat sink 160 is located to be connected to the optical emission interface 121.

In addition, in the figures, the first end of the optical fiber 140 is glued and fixed on the first surface 1601 via a glass head 1401, and the second end of the optical fiber 140 and the optical emission interface 121 are integrated into an optical interface structure with a pigtail. These specific structures are only examples, and the respective fixing manners of the first end and the second end of the optical fiber 140 in the present application are not limited thereto.

Furthermore, referring to FIG. 2 and FIG. 3, the optical module 100 further includes a flexible protective sleeve 170 sleeved on the outer periphery of the optical fiber 140. The flexible protective sleeve 170 is located at least at a junction between the optical fiber 140 and the through hole 1603, so as to protect the optical fiber 140 and prevent the optical fiber 140 from being damaged when being bent at the through hole 1603. In this embodiment, at the first end of the optical fiber 140, the flexible protective sleeve 170 continuously extends from the glass head 1401 to the side that the second surface 1602 of the heat sink 160 is located, such that the flexible protective sleeve 170 completely covers a section of the optical fiber 140 located in the through hole 1603 and a section located on the side that the first surface 1601 is located.

Furthermore, the fiber coiling member 150 is configured such that its accommodating cavity 1510 is open in the top-down direction away from the heat sink 160. In this way, the accommodating cavity 1510 is open relatively toward the rear side of the optical module 100, so as to facilitate the overall assembly of the optical module 100. For example, the fiber coiling member 150 and the heat sink 160 can be assembled first, and then the fiber coiling operation can be performed from the rear side.

Moreover, in the front-rear direction, referring to FIG. 3, the rear end of the fiber coiling body 151 is located behind a front end of the circuit board 110, and a front end of the fiber coiling body 151 is located in front of the front end of the circuit board 110. In other words, the rear end portion of the fiber coiling body 151 overlaps the circuit board 110 in the top-down direction, while the front end portion thereof extends forward out from the circuit board 110. In this way, the space of the optical module 100 in the front-rear direction can be fully utilized, such that the length of the optical fiber 140 can be adjusted to a greater extent (that is, the optional length range of the optical fiber 140 is wider), thereby reducing the design difficulty of the optical module 100.

In this embodiment, referring to FIG. 4, the front end portion of the fiber coiling body 151 has a through groove 155 formed on the bottom wall 1512 for the optical fiber 140 to pass through the accommodating cavity 1510. Thus, after the optical fiber 140 is coiled in the fiber coiling member 150, its two ends (i.e., the first end and the second end) can leave the accommodating cavity 1510 through the through groove 155 on the bottom wall 1512, and then extend to the heat sink 160 for connection with the optical emission assembly 131 and the optical emission interface 121.

At the same time, on this basis, the fiber coiling wall 1511 is arranged around the accommodating cavity 1510 in a closed ring shape, that is, it completely surrounds the accommodating cavity 1510 without an opening for the optical fiber 140 to pass through outward, thereby ensuring the bending radius of the optical fiber 140 during coiling.

In addition, in this embodiment, referring to FIG. 4, the fiber coiling member 150 is provided with a threaded hole 154; referring to FIG. 6, the heat sink 160 is correspondingly provided with a threaded hole 1604, and the fiber coiling member 150 is fixedly installed on the heat sink 160 through a threaded member. Naturally, the fiber coiling member 150 can also be changed to be fixedly installed on the heat sink 160 through other structures such as glue, buckles, etc.

It should be further noted that, in the accompanying figures, only the coiling and arrangement of the optical fiber 140 between the optical emission interface 121 and the optical emission assembly 131 in the fiber coiling member 150 are illustrated. As mentioned above, it can be understood that when the optical receiving interface 123 and the optical receiving assembly 132 are also connected by an optical fiber, the optical fiber can also be coiled and arranged in the fiber coiling member 150 to ensure the bending radius of the optical fiber and improve the power stability of the optical module 100, thereby improving the fiber coiling efficiency, and saving the fiber coiling time.

In addition, in this embodiment, regarding the specific components of the optical emission assembly 131, reference is made to FIG. 1 and FIG. 2; the optical emission assembly 131 specifically includes an optical emission chip 1311 electrically connected to the circuit board 110, and any one of a collimating lens 1312, a Mux multiplexer 1313, a first periscope 1315, and a second periscope 1316 arranged in sequence in the optical path between the optical emission chip 1311 and the coupling lens constituting the above-mentioned optical device 1317.

The optical emission chip 1311 is installed on a ceramic carrier and is electrically connected to the circuit board 110 via the ceramic carrier. It is known that the optical emission chip 1311 and the ceramic carrier are generally collectively referred to as a COC (chip on ceramics) assembly.

As for a specific optical path of the optical receiving assembly 132, referring to FIG. 1 and FIG. 2, the optical receiving assembly 132 specifically includes a transimpedance amplifier 1321 electrically connected to the circuit board 110, an optical receiving chip 1322 electrically connected to the transimpedance amplifier, and any one of an optical receiving module, a Mux demultiplexer 1325, and an isolator 1326 sequentially arranged in the optical path between the optical receiving chip 1322 and the optical receiving interface 123.

The COC component, the Mux multiplexer 1313, the first periscope 1315, the second periscope 1316, the coupling lens, the transimpedance amplifier 1321, the optical receiving chip 1322, the optical receiving module, the Mux demultiplexer 1325, and the isolator 1326 are all installed and fixed on the first surface 1601 of the heat sink 160. In addition, the circuit board 110 is also fixed on the first surface 1601 of the heat sink 160. The circuit board 110 has a window 1100. The transimpedance amplifier 1321 and the optical receiving chip 1322 are arranged in the window 1100 and are shielded by a sealing cover 180.

Naturally, in this embodiment, the specific components of the optical receiving assembly 132 and the optical emission assembly 131, the connection manner between the optical emission chip 1311 and the circuit board 110, and the installation position of the transimpedance amplifier 1321 and the optical receiving chip 1322 relative to the circuit board 110 are only for exemplification, and the present application can be implemented in other feasible ways known in the art.

### Second Embodiment

Referring to FIG. 7 and FIG. 8, this embodiment provides an optical module, which also includes components such as a circuit board, an optical interface, a photoelectric assembly, an optical fiber, a fiber coiling member 250, a heat sink, and a flexible protective sleeve.

The difference between this embodiment and the aforementioned first embodiment is only in the arrangement of an optical fiber installation channel 2P of the fiber coiling member 250. Only this difference will be described below, and other parts that are the same as the first embodiment will not be described in detail.

Specifically, in the aforementioned first embodiment, all of the optical fiber installation channels 1P are configured to be open away from the bottom wall 1512; furthermore, the guide wall 153 is in-out opposite to the fiber coiling wall 1511, and extends from the bottom wall 1512 along the thickness direction of the circuit board 110, and is spaced from the inner edge of the stop wall 152 (i.e., the edge away from the fiber coiling wall 1511) to form the optical fiber installation channels 1P.

In the present embodiment, all of the optical fiber installation channels 2P are arranged to be open away from a fiber coiling wall 2511. Therefore, when an optical fiber is coiled, the optical fiber is placed in an accommodating cavity 2510, and then passes through each of the optical fiber installation channels 2P in the periphery to enter a stop space 2510a on one side of a stop wall 252, so as to smoothly complete the fiber coiling of the optical fiber, which is quick and simple, thereby improving the fiber coiling efficiency, and saving the fiber coiling time.

Specifically, in this embodiment, a guide wall 253 is provided in the accommodating cavity 2510 of the fiber coiling member 250. The guide wall 253 is in-out opposite to the fiber coiling wall 2511, extends from the inner edge of the bottom wall 2512 (i.e., the edge away from the fiber coiling wall 2511) along the thickness direction of the circuit board 110, and is spaced from the bottom wall 2512 to form the optical fiber installation channel 2P.

### Third Embodiment

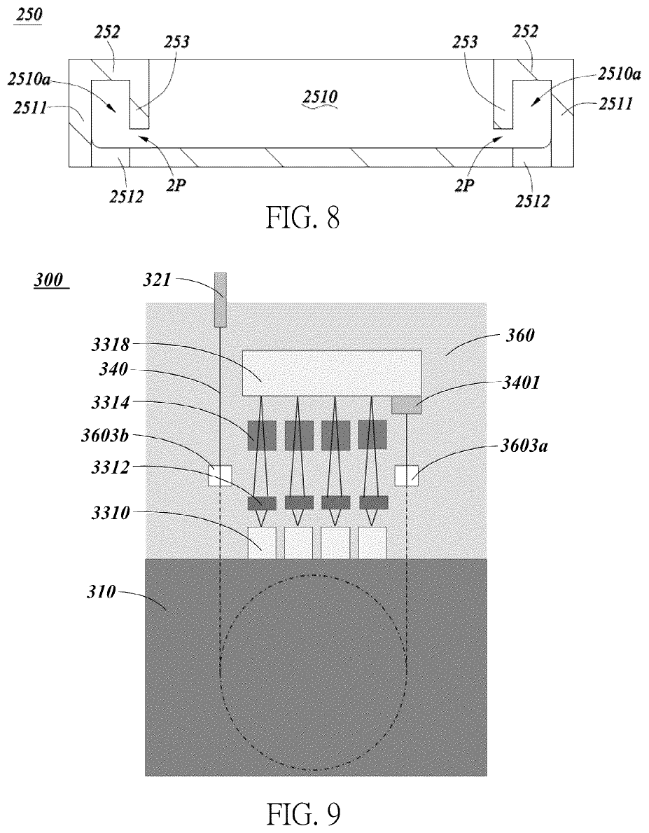

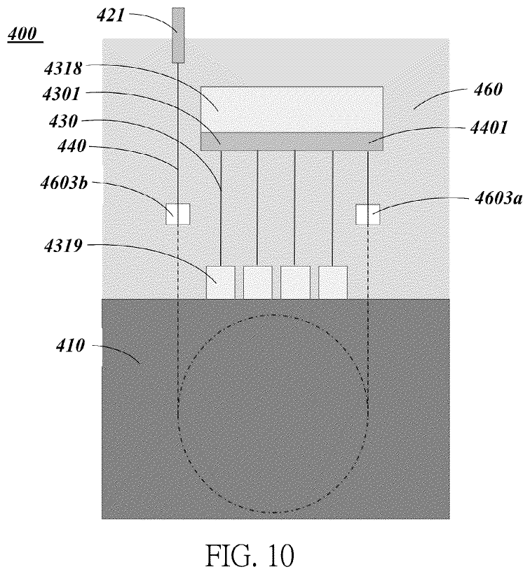

Referring to FIG. 9, this embodiment provides an optical module 300. Compared with the first embodiment or the second embodiment, this optical module 300 also includes components such as a circuit board 310, an optical interface, a photoelectric assembly, an optical fiber 340, a fiber coiling member, a heat sink 360, and a flexible protective sleeve. The difference between this embodiment and the aforementioned first embodiment (or the second embodiment) lies in that: the specific components of the optical emission assembly of the photoelectric assembly, the specific installation of the glass head 3401 of a first end of the optical fiber 340 (i.e., the end that the optical fiber 340 and the photoelectric assembly are optically connected), and the installation position of a second end of the optical fiber 340 and the optical emission interface 321 of the optical interface. Only these differences are introduced below, and the rest of the parts that are same as the first embodiment (or the second embodiment) are not repeated herein.

### <On Specific Components of the Optical Emission Module>

In the above-mentioned first embodiment (or the second embodiment), the optical emission assembly 131 specifically includes an optical emission chip 1311 electrically connected to the circuit board 110, and the optical emission chip 1311 is installed on a ceramic carrier and forms a COC component with the ceramic carrier. The optical emission assembly 131 further includes the collimating lens 1312, the Mux multiplexer 1313, the isolator 1314, the first periscope 1315, the second periscope 1316, the coupling lens (labeled as 1317 in FIG. 1), etc., which are sequentially arranged on the light output path of the optical emission chip 1311.

In this embodiment, the optical emission assembly includes an optical emission chip electrically connected to the circuit board 310, and the optical emission chip is installed on a ceramic carrier and forms a COC component 3310 with the ceramic carrier. In addition, different from the first embodiment (or the second embodiment), the optical emission assembly of this embodiment further includes a collimating lens 3312, an isolator 3314, an array waveguide grating (AWG) 3318, etc., which are sequentially arranged on the light output path of the optical emission chip. In this way, the light that is output from the optical emission chip sequentially enters the collimating lens 3312, the isolator 3314, and then enters the array waveguide grating 3318 for wave combination.

### <On the Specific Installation of Glass Head 3401>

In the aforementioned first embodiment (or the second embodiment), the first end of the optical fiber 140 is fixed to the first surface 1601 of the heat sink 160 via the glass head 1401. Alternatively, in this embodiment, the first end of the optical fiber 340 (i.e., the end of the optical fiber 340 that is optically connected to the photoelectric assembly) is coupled and adhered to an emission end surface of the array waveguide grating 3318 via the glass head 3401, such that the optical signal after being combined by the array waveguide grating 3318 enters the optical fiber 340 via the glass head 3401, and finally is emitted from the optical emission interface 321.

### <On Installation Position of the Second End of the Optical Fiber 340 and the Optical Emission Interface 321 of the Optical Interface>

In the above-mentioned first embodiment (or the second embodiment), the number of through holes 1603 is set to be one, and the second end of the optical fiber 140 and the optical emission interface 121 are integrated into an optical interface structure with a pigtail, and are fixedly installed on the side that the second surface 1602 of the heat sink 160 is located. In this way, after the optical fiber 140 is coiled on the side that the second surface of the heat sink 160 is located, only the first end of the optical fiber 140 needs to pass through the through hole 1603 to the side that the first surface 1601 of the heat sink 160 is located.

In this embodiment, the first end of the optical fiber 340 is arranged on a side that a first surface of the heat sink 360 is located, and the first surface can be used to fixedly install the photoelectric assembly and the circuit board 310 of the optical module 300; but different from the first embodiment (or the second embodiment), the heat sink 360 in this embodiment is provided with two through holes, which are respectively marked as a through hole 3603a and a through hole 3603b in the figure, and the second end of the optical fiber 340 and the optical emission interface 321 are integrated into an optical interface structure with a pigtail, and are fixedly installed on the side that the first surface of the heat sink 360 is located.

In this way, a middle section of the optical fiber 340 is coiled in the fiber coiling member on a side that a second surface of the heat sink 360 is located. The first end of the optical fiber 340 passes through the through hole 3603a to the side that the first surface of the heat sink 360 is located, so as to be optically coupled with the optical emission assembly installed on the first surface of the heat sink 360. Similarly, the second end of the optical fiber 340 passes through the through hole 3603b to the side that the first surface of the heat sink 360 is located, so as to be connected to the optical emission interface 321.

Naturally, it can be understood that the optical module in this embodiment can also be implemented in a modified manner of: the through hole 3603b being eliminated and the second end of the optical fiber 340 being connected to the optical emission interface 321 on the side that the second surface of the heat sink 360 is located as in the aforementioned first embodiment.

### Fourth Embodiment

Referring to FIG. 10, this embodiment provides an optical module 400. Compared with the third embodiment, the optical module 400 also includes components such as a circuit board 410, an optical interface, a photoelectric assembly, an optical fiber 440, a fiber coiling member, a heat sink 460, and a flexible protective sleeve. The difference between this embodiment and the aforementioned third embodiment is only in the specific components of the optical emission assembly of the photoelectric assembly. Only such difference is introduced below, and the other parts that are the same as the third embodiment are not repeated.

Specifically, in this embodiment, the optical emission assembly specifically includes an optical emission submodule 4319 with a built-in isolator. The optical emission submodule 4319 is electrically connected to the circuit board 410 through pin welding or flexible board welding, and is used to convert electrical signals into optical signals.

The optical emission assembly further includes an optical fiber 430, a glass head 4301 with a pigtail, and an array waveguide grating 4318 sequentially arranged on the light output path of the optical emission submodule 4319; the glass head 4301 with a pigtail is connected to the optical fiber 430, and is coupled and adhered on a receiving end surface of the array waveguide grating 4318. In this way, the light output by the optical emission submodule 4319 sequentially enters the optical fiber 430, the glass head 4301 with a pigtail, and the array waveguide grating 4318, and after being combined by the array waveguide grating 4318, enters the optical fiber 440 through a glass head 4401 with a pigtail, and is finally emitted from the optical emission interface 421.

In which, the receiving end surface and the emission end surface of the array waveguide grating 4318 are formed on the same side of the array waveguide grating 4318; accordingly, the glass head 4301 with the pigtail and the glass head 4401 of the first end (that is, the end of the optical fiber 440 that is optically connected to the photoelectric assembly) of the optical fiber 440 are located on the same side of the array waveguide grating 4318 and are arranged integrally.

In addition, similar to the third embodiment, the heat sink 460 of the present embodiment also has two through holes 4603a and 4603b for the optical fiber 440 to pass through between the first surface and the second surface of the heat sink 460. It can be understood that the optical module of the present embodiment can also be implemented in a modified manner of: the through hole 4603b being eliminated and a second end of the optical fiber 440 being connected to the optical emission interface 421 on a side that the second surface of the heat sink 460 is located as in the aforementioned first embodiment.

In summary, the present application has the following beneficial effects of: on the one hand, the optical fiber can be stably attached to the inner side of the fiber coiling wall by utilizing its own tension when it is bent; no matter whether the optical fiber is coiled in a single circle or multiple circles in the fiber coiling member, the bending radius of the optical fiber can be ensued to always meet the requirements and does not change inadvertently, thereby ensuring the power stability of the optical module; on the other hand, there is no need to deliberately correct the position/bending radius of the optical fiber during the fiber coiling process, and the optical fiber can be coiled quickly and easily, thereby improving the fiber coiling efficiency and saving the fiber coiling time.

It should be understood that although this specification is described according to implementations, not each of the implementations contains only one independent technical solution. This description of the specification is only for the sake of clarity, and those skilled in the art should regard the specification as a whole. The technical solutions in each of the implementations may also be appropriately combined to form other implementations that can be understood by those skilled in the art.

The series of detailed descriptions listed above are only specific descriptions of feasible implementations of the present application. They are not intended to limit the scope of protection of the present application. Any equivalent implementations or changes that do not deviate from the technical spirit of the present application should be included in the scope of protection of the present application.

What is claimed is:

1. An optical module, comprising: a circuit board, a photoelectric assembly electrically connected to the circuit board, an optical interface, an optical fiber in optical communication with the photoelectric assembly and the optical interface, and a fiber coiling member, wherein the fiber coiling member includes:
a fiber coiling body enclosing an accommodating cavity, and the fiber coiling body is provided with a bottom wall and a fiber coiling wall extending from the bottom wall in the thickness direction of the circuit board, wherein the fiber coiling wall defines a peripheral boundary of the accommodating cavity; and
a stop wall arranged opposite to the bottom wall in the thickness direction of the circuit board and protruding from the fiber coiling wall to the interior of the accommodating cavity, and the accommodating cavity is provided with a stop space formed between the stop wall and the bottom wall;
wherein the optical fiber coils and extends along the fiber coiling wall and is limited in the stop space by the stop wall.

2. The optical module according to claim 1, wherein the fiber coiling member includes plurality ones of the stop wall spaced apart from each other and arranged around the accommodating cavity, the fiber coiling member limits an optical fiber installation channel formed at each of the stop walls for the optical fiber to enter or leave the stop space, and all of the fiber installation channels are arranged to be open away from the bottom wall or are arranged to be open away from the fiber coiling wall.

3. The optical module according to claim 1, wherein the fiber coiling member further includes a guide wall located in the accommodating cavity and is in-out opposite to the fiber coiling wall, and the guide wall extends from one of the bottom wall and the stop wall along the thickness direction of the circuit board, and is spaced apart from another one of the bottom wall and the stop wall to form an optical fiber installation channel.

4. The optical module according to claim 1, further comprising a heat sink; wherein the heat sink has a first surface and a second surface arranged opposite to each other along the thickness direction of the circuit board, at least part of the photoelectric assembly and the circuit board are installed on the first surface, and the fiber coil is located on a side that the second surface is located;
the heat sink further has a through hole connecting the first surface and the second surface, and the optical fiber passes through the through hole between a side that the first surface is located and the side that the second surface is located.

5. The optical module according to claim 4, further comprising a flexible protective sleeve sleeved on the outer periphery of the optical fiber, wherein the flexible protective sleeve is located at least at a junction between the optical fiber and the through hole.

6. The optical module according to claim 4, wherein the photoelectric assembly includes a first optical device installed on the first surface;
a number of the through hole is set to one; a portion of the optical fiber is coiled in the fiber coiling member, one end of the optical fiber passes through the through hole to the side that the first surface is located to optically couple with the first optical device, and another end of the optical fiber is connected to the optical interface;
alternatively, a number of the through hole is set to two; a portion of the optical fiber is coiled in the fiber coiling member, one end of the optical fiber passes through one of the through holes to the side that the first surface is located to optically couple with the first optical device, and another end of the optical fiber passes through another one of the through holes to the side that the first surface is located to be connected to the optical interface.

7. The optical module according to claim 6, wherein the photoelectric assembly includes:
an optical emission assembly connected to the optical interface through the optical fiber; and/or
an optical receiving assembly connected to the optical interface through the optical fiber.

8. The optical module according to claim 7, wherein the first optical device is configured as a coupling lens, and one end of the optical fiber is coupled to the coupling lens via a glass head;
alternatively, the first optical device is configured as an array waveguide grating, and one end of the optical fiber is coupled and adhered to an emission end surface of the array waveguide grating via a glass head.

9. The optical module according to claim 8, wherein the optical emission assembly includes any of a collimating lens, a Mux multiplexer, a first periscope, and a second periscope located in an incident optical path of the coupling lens;
alternatively, the optical emission assembly includes a collimating lens and an isolator located in an optical path between the array waveguide grating;
alternatively, the optical emission assembly includes a second optical fiber located in an optical path between the array waveguide grating, one end of the second optical fiber is coupled and adhered to a receiving end surface of the array waveguide grating through a second glass head, and the second glass head and the glass head are located on a same side of the array waveguide grating and are integrally arranged.

10. The optical module according to claim 4, wherein the optical interface is located in front of the circuit board;
a rear end portion of the fiber coiling body overlaps with the circuit board along the thickness direction of the circuit board; and
a front end portion of the fiber coiling body extends forward from the circuit board.

11. The optical module according to claim 10, wherein the front end portion of the fiber coiling body has a through groove formed on the bottom wall for the optical fiber to pass through the accommodating cavity;
the fiber coiling wall is arranged around the accommodating cavity in a closed ring shape.

12. The optical module according to claim 4, wherein the fiber coiling member is fixedly installed on the second surface of the heat sink by any structure of a screw member, a glue, or a buckle.
